(19) United States
(12) Patent Application Publication
(10) Pub. No.: US 2015/0311481 A1
(43) Pub. Date: Oct. 29, 2015

(54) Cap Assembly Of Power Battery

(71) Applicant: Ningde Amperex Technology Limited, Ningde (CN)

(72) Inventors: Qiong QU, Ningde (CN); Quankun LI, Ningde (CN); Pinghua DENG, Ningde (CN); Peng WANG, Ningde (CN)

(21) Appl. No.: 14/574,231

(22) Filed: Dec. 17, 2014

(30) Foreign Application Priority Data
Apr. 25, 2014 (CN) 201420207397.7

(51) Int. Cl. H01M 2/04; H01M 2/12

(52) U.S. Cl. CPC H01M 2/0473; H01M 2/12

(57) ABSTRACT

The present disclosure provides a cap assembly of a power battery, which comprises: a cap plate provided with a vent hole and an electrolyte-injection hole; a first electrode post provided on and electrically connected to the cap plate; a second electrode post insulated from and assembled to the cap plate 1; a vent fixedly provided on the vent hole; and a boss provided on the cap plate. The cap assembly of the power battery of the present disclosure can improve the strength of the cap plate at the vent, has simple structure, is easy formed and has low processing cost by provision of the boss.

### CROSS-REFERENCE TO RELATED APPLICATIONS

The present application claims priority to Chinese patent application No. 201420207397.7 filed on Apr. 25, 2014, which is incorporated herein by reference in its entirety.

### TECHNICAL FIELD OF THE PRESENT DISCLOSURE

The present disclosure relates to the field of power battery, and particularly relates to a cap assembly of power battery.

### BACKGROUND OF THE PRESENT DISCLOSURE

With the development of modern society and people's awareness of environmental protection, electric vehicles are increasingly inclined to use lithium-ion batteries as their energy sources. A power battery should not only have a high capacity, should also have high safety and long cycle life. Generally, a cap assembly of the battery is provided with a vent, when an accident happens to the battery, a large amount of gas will be produced in the battery to open the vent, so the safety of the battery is improved to a certain extent.

However, the strength of the cap plate at the vent will be reduced due to the existence of the vent, and the cap plate is easily deformed in the assembling process of the battery and in turn to cause the burst pressure of the vent to be reduced; on the other hand, the vent may be contaminated by an electrolyte and the like in the electrolyte injecting process of the battery. A lithium-ion battery with ideal safety performance and battery pack is disclosed in Chinese patent application publication No. CN103474599A, published on Dec. 25, 2013, in which a mesh cover can also solve this problem, but the mesh cover needs to be welded and sealed on a cap plate, a quality rate of welding and sealing is only about 75%, cost is high. A power battery with metal shell is disclosed in Chinese patent application issuance publication No. CN202405327U published on Aug. 29, 2012, in which a vent of the power battery can also solve the problems that the strength of the cap plate is reduced and the vent is contaminated by an electrolyte, but the vent of the power battery has complex structure and high processing cost.

### SUMMARY OF THE PRESENT DISCLOSURE

In view of the problem existing in the background, an object of the present disclosure is to provide a cap assembly of a power battery, which not only improves the strength of a cap plate at a vent and also has the advantages of simple structure, easy forming and low processing cost.

In order to achieve the above objects, the present disclosure provides a cap assembly of a power battery, which comprises: a cap plate provided with a vent hole and an electrolyte-injection hole; a first electrode post provided on and electrically connected to the cap plate; a second electrode post insulated from and assembled to the cap plate 1; a vent fixedly provided on the vent hole; and a boss provided on the cap plate.

The present disclosure has the following beneficial effects:

The cap assembly of the power battery of the present disclosure can improve the strength of the cap plate at the vent, has simple structure, is easy formed and has low processing cost by provision of the boss.

### BRIEF DESCRIPTION OF THE FIGURES

FIG. 1 is a perspective view of an embodiment of a cap assembly of a power battery according to the present disclosure;

FIG. 2 is an enlarged perspective view of a circled portion of FIG. 1;

FIG. 3 is a cross-sectional view taken along a line A-A of FIG. 2;

FIG. 4 is a top view of FIG. 2;

FIG. 5 is an enlarged perspective view of another embodiment of the circled portion of FIG. 1;

FIG. 6 is a cross-sectional view taken along a line B-B of FIG. 5;

FIG. 7 is a top view of FIG. 5;

FIG. 8 is a top view of another embodiment of the circled portion of FIG. 1; and

FIG. 9 is a view of another embodiment of FIG. 2.

Reference numerals of the embodiments are represented as follows:

| | |
|---|---|
| 1 | cap plate |
| 11 | upper surface |
| 2 | vent hole |
| 21 | inner side edge |
| 3 | electrolyte-injection hole |
| 4 | first electrode post |
| 5 | second electrode post |
| 6 | vent |
| 7 | boss |
| 71 | inner side edge |
| 72 | outer side edge |
| H | height |
| T | thickness |
| L | length |

### DETAILED DESCRIPTION

Hereinafter a cap assembly of a power battery according to the present disclosure will be described in detail in combination with the figures.

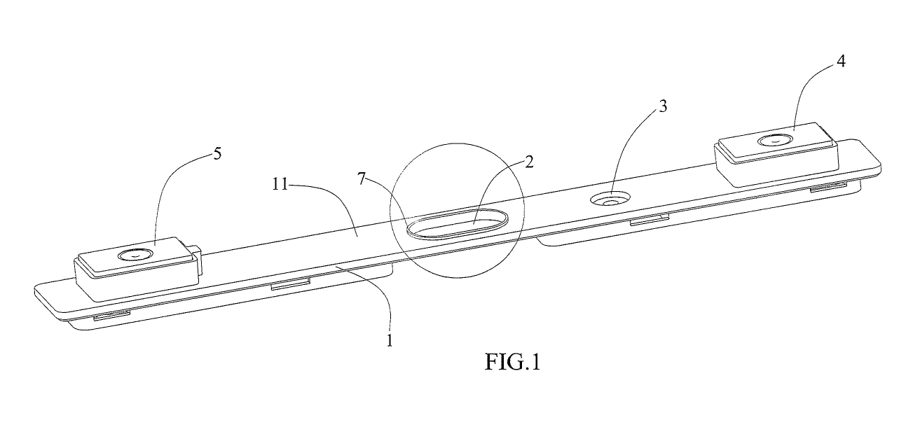

Referring to FIGS. 1-9, a cap assembly of a power battery according to the present disclosure comprises: a cap plate 1 provided with a vent hole 2 and an electrolyte-injection hole 3; a first electrode post 4 provided on and electrically connected to the cap plate 1; a second electrode post 5 insulated from and assembled to the cap plate 1; a vent 6 fixedly provided on the vent hole 2; and a boss 7 provided on the cap plate 1.

The cap assembly of the power battery of the present disclosure is provided with the boss 7, which can improve the strength of the cap plate 1 at the vent 6, and has the advantages of simple structure, easy forming and low processing cost.

In an embodiment of the cap plate 1, the cap plate 1 may be made of aluminum or stainless steel.

In an embodiment of the cap plate 1, the cap plate 1 may be rectangular, circular or oval in shape. Specifically, in the examples shown in FIGS. 1-9, the cap plate 1 is rectangular in shape, but is not limited to that.

In an embodiment of the cap assembly of the power battery according to the present disclosure, the first electrode post 4 may be electrically connected to the cap plate 1 by welding, riveting, or a conducting element (not shown).

In an embodiment of the cap assembly of the power battery according to the present disclosure, the second electrode post 5 may be insulated from and assembled to the cap plate 1 by injection molding, or an insulating element (not shown).

In an embodiment of the cap assembly of the power battery according to the present disclosure, referring to FIG. 9, an upper surface 11 of the cap plate 1 may be welded with the boss 7. In an embodiment, a lower surface of the cap plate 1 may be welded with the boss 7. In another embodiment, the upper surface 11 of the cap plate 1 may be welded with the boss 7 and the lower surface of the cap plate 1 may be welded with the boss 7. In an embodiment, the boss 7 and the cap plate 1 are integrally formed and the upper surface 11 (referring to FIG. 9) of the cap plate 1 is formed with the boss 7 and/or the lower surface of the cap plate 1 is formed with the boss 7. As for the number of the boss 7 on one surface (the upper surface 11 or the lower surface) of the cap plate 1, may be one, two (referring to FIG. 9), three or more.

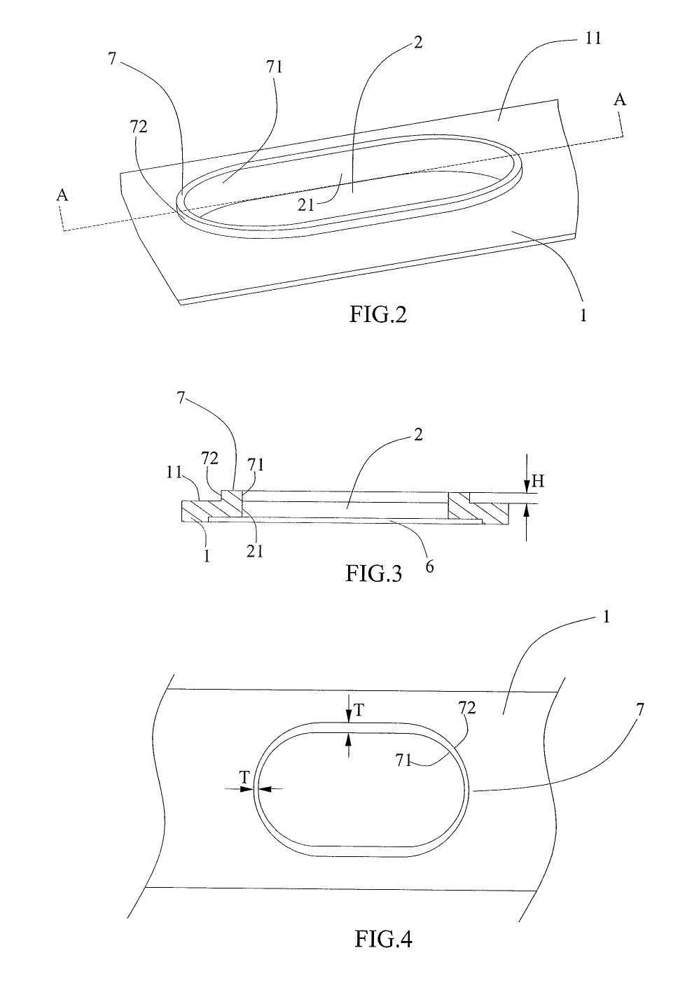

In an embodiment of the cap assembly of the power battery according to the present disclosure, referring to FIGS. 3-8, the boss 7 is integrally formed with cap plate 1 and is provided on the upper surface 11 of the cap plate 1 around the vent hole 2. In this case, the boss 7 can also be used to prevent the electrolyte from flowing to the vent 6.

In an embodiment of the cap assembly of the power battery according to the present disclosure, referring to FIG. 3 and FIG. 9, an inner side edge 71 of the boss 7 may be aligned with an inner side edge 21 of the vent hole 2.

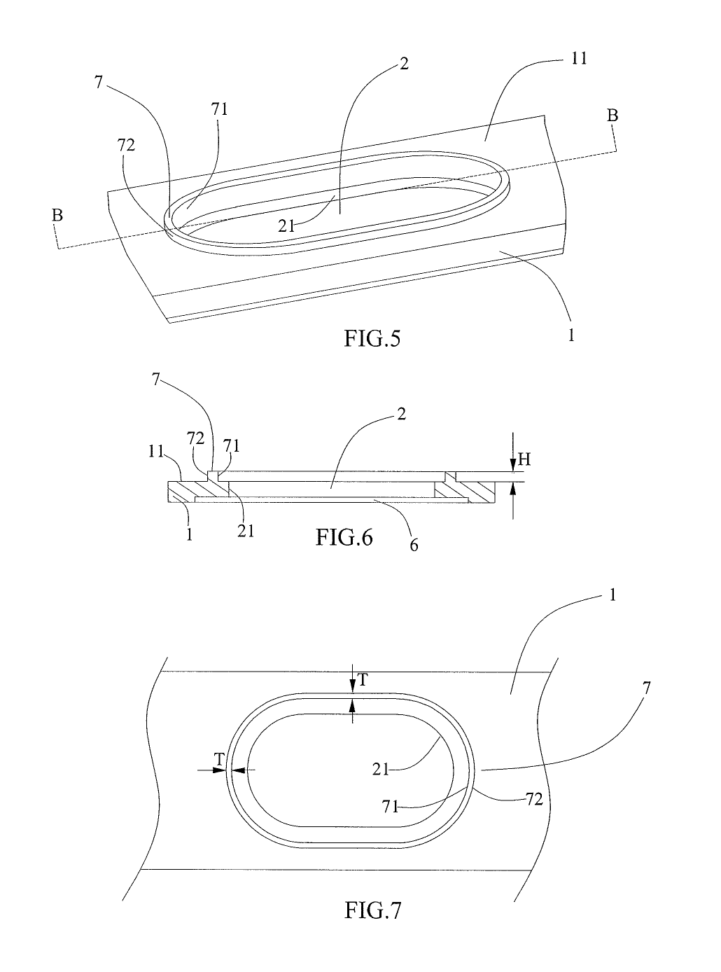

In an embodiment of the cap assembly of the power battery according to the present disclosure, referring to FIGS. 5-7, the inner side edge 71 of the boss 7 may be positioned inside an area surrounded by the inner side edge 21 of the vent hole 2. In another embodiment, the inner side edge 71 of the boss 7 may be positioned outside an area surrounded by the inner side edge 21 of the vent hole 2.

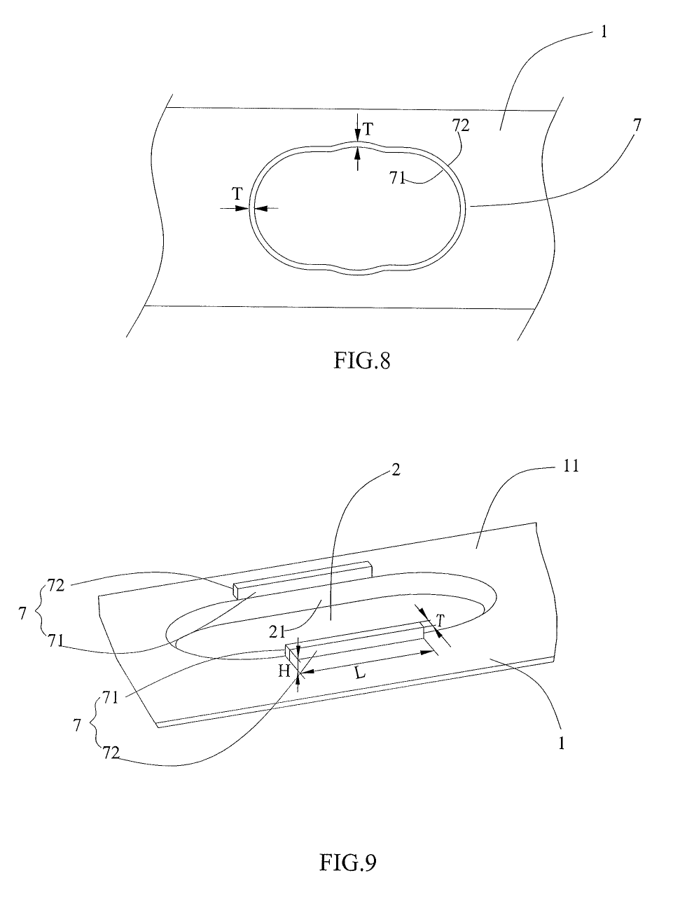

In an embodiment of the cap assembly of the power battery according to the present disclosure, referring to FIG. 4, FIG. 7 and FIG. 8, FIG. 9, an inner contour defined by the inner side edge 71 of the boss 7 and an outer contour defined by the outer side edge 72 of the boss Tare geometrically similar or geometrically dissimilar. Specifically, in the examples shown in FIG. 7, FIG. 8 and FIG. 9, an inner contour defined by the inner side edge 71 of the boss 7 and an outer contour defined by the outer side edge 72 of the boss 7 are geometrically similar; in the example shown in FIG. 4, the inner contour defined by the inner side edge 71 of the boss 7 and the outer contour defined by the outer side edge 72 of the boss 7 are geometrically dissimilar. In an embodiment, the inner contour defined by the inner side edge 71 of the boss 7 and the outer contour defined by the outer side edge 72 of the boss 7 may be rectangular, circular, oval, or irregular in shape. Specifically, in the examples shown in FIG. 4 and FIG. 7, the inner contour defined by the inner side edge 71 of the boss 7 and the outer contour defined by the outer side edge 72 of the boss 7 are oval in shape; in the example shown in FIG. 8, the inner contour defined by the inner side edge 71 of the boss 7 and the outer contour defined by the outer side edge 72 of the boss 7 are irregular in shape, but it is not limited to that in practical application.

In an embodiment of the boss 7, referring to FIG. 3 and FIG. 6, a height H of the boss 7 may be 0.5 mm˜2.0 mm.

In an embodiment of the boss 7, referring to FIG. 4, FIG. 7, FIG. 8 and FIG. 9, a thickness T of the boss 7 may be 0.5 mm˜5.0 mm, it should be understood that the thickness T of the boss 7 is a distance between the inner side edge 71 and the corresponding outer side edge 72 of the boss 7.

In an embodiment of the boss 7, referring to FIG. 4, FIG. 7, FIG. 8 and FIG. 9, the thickness T of the boss 7 is uniform or non-uniform. Specifically, in the example shown in FIG. 4, the thickness T of the boss 7 is non-uniform; in the example shown in FIG. 7, FIG. 8 and FIG. 9, the thickness T of the boss 7 is uniform.

In an embodiment of the boss 7, referring to FIG. 9, a length L of the boss 7 may be 5 mm˜50 mm.

While the present disclosure may be susceptible to embodiments in different forms, only specific embodiments are shown in the figures and herein will be described in detail. With the understanding that, unless otherwise noted, features disclosed herein may be combined together to form additional combinations those were not otherwise shown for purposes of brevity.

What is claimed is:

1. A cap assembly of a power battery, comprising:
a cap plate (1) provided with a vent hole (2) and an electrolyte-injection hole (3);
a first electrode post (4) provided on and electrically connected to the cap plate (1);
a second electrode post (5) insulated from and assembled to the cap plate (1); and
a vent (6) fixedly provided on the vent hole (2);
the cap assembly of the power battery further comprising:
a boss (7) provided on the cap plate (1).

2. The cap assembly of the power battery according to claim 1, wherein
the first electrode post (4) is electrically connected to the cap plate (1) by welding, riveting, or a conducting element;
the second electrode post (5) is insulated from and assembled to the cap plate (1) by injection molding, or an insulating element.

3. The cap assembly of the power battery according to claim 1, wherein an upper surface (11) of the cap plate (1) is welded with the boss (7) and/or a lower surface of the cap plate (1) is welded with the boss (7), or the boss (7) and the cap plate (1) are integrally formed and the upper surface (11) of the cap plate (1) is formed with the boss (7) and/or the lower surface of the cap plate (1) is formed with the boss (7).

4. The cap assembly of the power battery according to claim 1, wherein the boss (7) is integrally formed with the cap plate (1) and is provided on the upper surface (11) of the cap plate (1) around the vent hole (2).

5. The cap assembly of the power battery according to claim 3, wherein an inner side edge (71) of the boss (7) is aligned with an inner side edge (21) of the vent hole (2).

6. The cap assembly of the power battery according to claim 4, wherein an inner side edge (71) of the boss (7) is aligned with an inner side edge (21) of the vent hole (2).

7. The cap assembly of the power battery according to claim 4, wherein
an inner side edge (71) of the boss (7) is positioned inside an area surrounded by an inner side edge (21) of the vent hole (2); or
the inner side edge (71) of the boss (7) is positioned outside an area surrounded by the inner side edge (21) of the vent hole (2).

8. The cap assembly of the power battery according to claim 3, wherein an inner contour defined by an inner side edge (71) of the boss (7) and an outer contour defined by an outer side edge (72) of the boss (7) are geometrically similar or geometrically dissimilar.

9. The cap assembly of the power battery according to claim 4, wherein an inner contour defined by an inner side edge (71) of the boss (7) and an outer contour defined by an outer side edge (72) of the boss (7) are geometrically similar or geometrically dissimilar.

10. The cap assembly of the power battery according to claim 3, wherein a height (H) of the boss (7) is 0.5 mm˜2.0 mm; a thickness (T) of the boss (7) is 0.5 mm˜5.0 mm.

11. The cap assembly of the power battery according to claim 4, wherein a height (H) of the boss (7) is 0.5 mm˜2.0 mm; a thickness (T) of the boss (7) is 0.5 mm˜5.0 mm.

12. The cap assembly of the power battery according to claim 3, wherein the thickness (T) of the boss (7) is uniform or non-uniform.

13. The cap assembly of the power battery according to claim 4, wherein the thickness (T) of the boss (7) is uniform or non-uniform.

14. The cap assembly of the power battery according to claim 3, wherein a length (L) of the boss (7) is 5 mm˜50 mm.
